(19) United States
(12) Patent Application Publication
(10) Pub. No.: US 2014/0052556 A1
(43) Pub. Date: Feb. 20, 2014

(54) SYSTEM AND A METHOD FOR EBOOK DISTRIBUTION AND MONETIZATION

(71) Applicant: Ayelet Geva, Tel Aviv (IL)

(72) Inventor: Ayelet Geva, Tel Aviv (IL)

(21) Appl. No.: 13/584,997

(22) Filed: Aug. 14, 2012

(51) Int. Cl. G06Q 30/06

(52) U.S. Cl. CPC G06Q 30/0601
USPC 705/26.1

(57) ABSTRACT

A website-based system for eBook distribution and monetization and to enhance the eBook reading experience by insertion into the eBook format of content from other media providers. The system includes at least one server to interact with authors/publishers, content consumers and eBook readers and a readily searchable database compiled from relevant media. The system also includes a runtime engine to map the eBooks and to search the database as needed and tools that will enable the insertion of other media into the eBook, such as photos, music, video, flash elements and content placement into the eBook, thereby creating a better user experience, one that will round out the reading process and create a hand shake between authors and other media artists.

### FIELD OF THE INVENTION

The present invention generally relates to eBook marketing, and more particularly to a system and a method for eBook distribution and monetization

### BACKGROUND OF THE INVENTION

There are various marketing methods available for artists to promote their work. Musicians, for example are able to reach their audience using social networks, iTunes, Spoty etc. While musicians benefit from an assortment of distribution and monetization channels, authors/publishers who wish to promote their eBook are still struggling with limited options. Authors, who wish to publish in the digital world, and publishers themselves can either monetize their product through distribution sites such as Amazon or create their own website. Both alternatives require authors/publishers to engage in intensive marketing efforts rather than focus on their art.

eBooks are taking over the publishing world as a result of e-readers such as Kindel, iPad, Nook etc. Amazon predicts it will sell more eBooks than paperbacks by the end of 2012. eBooks sales are expected to reach $9.7 billion worldwide in 2016. While eBook sales are rising, the marketing channels available for the eBooks are still extremely limited.

Thus, it would be advantageous to provide a social networking system for authors/publishers to facilitate distribution and monetization of their eBooks.

### SUMMARY OF THE INVENTION

Accordingly, it is a principal object of the present invention to provide a social networking system for authors/publishers to distribute and monetize their eBooks.

It is another principal object of the present invention to provide tools that will enable the insertion of other media, such as photos, music, video, flash elements and content placement into the eBook. This will create a better user experience, one that wifl complete the reading process and create a hand shake between authors and other media artists. The hand shake will result in a joint audience as both participants will expose their work to the other's audience.

It is still a further principal object of the present invention to provide a tool-set to empower independent authors and publishers to promote their eBooks.

It is one other principal object of the present invention to provide a tool-set for authors/publishers to enable an insertion of elements from other media into their eBook.

It is one further principal object of the present invention to provide for insertion into eBooks of other components such as games, videos, photos, music, as well as to promote product placement to expand the eBooks target audience, enhance engagement and increase stickiness.

A website-based system is disclosed for eBook distribution and monetization and to enhance the eBook reading experience by insertion into the eBook format of other media from other media providers. The system includes at least one server to interact with authors/publishers, content consumers and eBook readers and a readily searchable database compiled from relevant media. The system also includes a runtime engine to map the eBooks and to search the database as needed and tools that will enable the insertion of other media into the eBook, such as photos, music, video, flash elements and content placement into the eBook, thereby creating a better user experience, one that will round out the reading process and create a hand shake between authors and other media artists.

Authors will be able to search for cooperation with other media makers using one of three options:

Tag Words—Words that define the content of the eBook;

Association—The system will scan the eBook and form a tree of association that best define the content of the eBook; and

Content application—Authors/publishers search for Garners, Movie makers, Flash programmers, photographers etc., who have submitted applications for cooperation, seeking a particular subject to publish.

A variety of revenue models will help authors and publishers to monetize their titles in a more efficient way, and achieve a faster return-on-investment (ROI). Models such as revenue share, content oriented advertising, in-site promotion tools, and subscription will become available.

### Advantages of the Present Invention

Higher and faster ROI for the author;

Wider exposure of the eBooks;

Engagement—a close interaction between authors and readers;

Stickiness—Rich content encourages revisits and intensive usage;

Viral-Free platform; and

Better user experience.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIG. 1 is a schematic illustration of the system used for eBook distribution and monetization, constructed according to an exemplary embodiment of the present invention;

FIG. 2 is a schematic diagram of a content depository/content analyzer (CDCA), constructed according to the principles of the present invention;

FIG. 3 is a flow chart of the author/publisher submission process, constructed according to exemplary embodiments of the present invention;

FIG. 4 is a flow chart of how the author/publisher begins the subscription process, constructed according to exemplary embodiments of the present invention;

FIG. 5 is a flow chart of the author/publisher tag word subscription process, constructed according to exemplary embodiments of the present invention;

FIG. 6 is a flow chart of the author/publisher association subscription process, constructed according to exemplary embodiments of the present invention;

FIG. 7 is a flow chart of the author/publisher content application subscription process, constructed according to exemplary embodiments of the present invention;

FIG. 8 is a flow chart of how the content application providers get started, constructed according to exemplary embodiments of the present invention;

FIG. 9 is a screen shot layout of the 1^{st} of 5 tag word screens, constructed according to exemplary embodiments of the present invention;

FIG. 10 is a screen shot layout of the 2^{nd} of 5 tag word screens, constructed according to exemplary embodiments of the present invention;

FIG. 11 is a screen shot layout of the 3^{rd} of 5 tag word screens, constructed according to exemplary embodiments of the present invention;

FIG. 12 is a screen shot layout of the 4^{th} of 5 tag word screens, constructed according to exemplary embodiments of the present invention;

FIG. 13 is a screen shot layout of the 5^{th} of 5 tag word screens, constructed according to exemplary embodiments of the present invention;

FIG. 14 is a screen shot layout of the 1^{st} of 5 association screens, constructed according to exemplary embodiments of the present invention;

FIG. 15 is a screen shot layout of the 2^{nd} of 5 association screens, constructed according to exemplary embodiments of the present invention;

FIG. 16 is a screen shot layout of the 3^{rd} of 5 association screens, constructed according to exemplary embodiments of the present invention;

FIG. 17 is a screen shot layout of the 1^{st} of 3 content application screens, constructed according to exemplary embodiments of the present invention;

FIG. 18 is a screen shot layout of the 2^{nd} of 3 content application screens, constructed according to exemplary embodiments of the present invention;

FIG. 19 is a screen shot layout of the 3^{rd} of 3 content application screens, constructed according to exemplary embodiments of the present invention; and

FIG. 20 is a screen shot layout of a reader search of the data base for favorite eBooks, constructed according to exemplary embodiments of the present invention.

All the above and other characteristics and advantages of the invention will be further understood through the following illustrative and non-limitative description of preferred embodiments thereof.

### DETAILED DESCRIPTION OF PREFERRED EMBODIMENTS

The principles and operation of a method and an apparatus according to the present invention may be better understood with reference to the drawings and the accompanying description, in which like numerals designate corresponding elements throughout, it being understood that these drawings are given for illustrative purposes only and are not meant to be limiting.

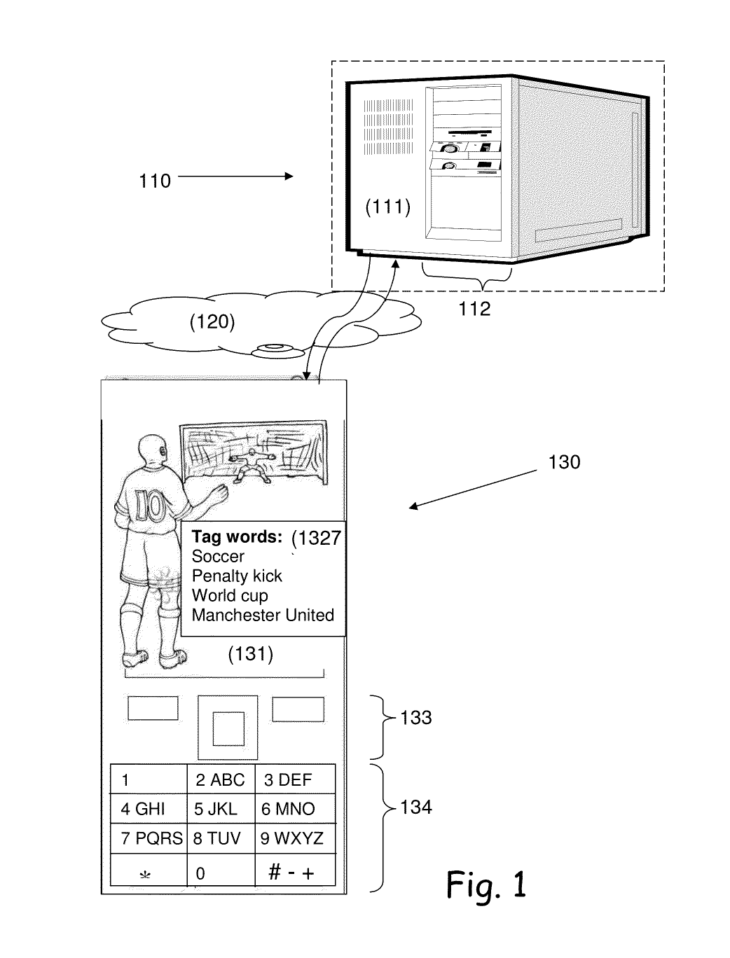

FIG. 1 is a schematic illustration of the system used for eBook distribution and monetization, constructed according to an exemplary embodiment of the present invention. A proprietary website 110 is provided to enable subscription and search. Website 110 includes servers 111 and database storage 112. Website 110 is in communication with subscribers over the Internet 120. Subscribers are equipped with smartphone, tabloid, laptop, PC or any other digital means 130. In the current example the pictured activity on the screen 131 of smartphone 130 shows a soccer player getting ready to make a penalty kick. Tag words 132 relating to pictured activity 131 have been entered by an author/publisher. In a preferred embodiment smartphone 130 has specialized function keys 133 to perform subscribing and searching, as well as a standard keypad 134.

In this example entry of tag words 132 may have initiated a media search resulting in retrieval of pictured activity 131 among dozens, hundreds or many thousands as a still photo from a newspaper or magazine or as a single video frame from a TV show or motion picture. The results of such retrieval are preferably weighted and ranked and displayed in order accordingly.

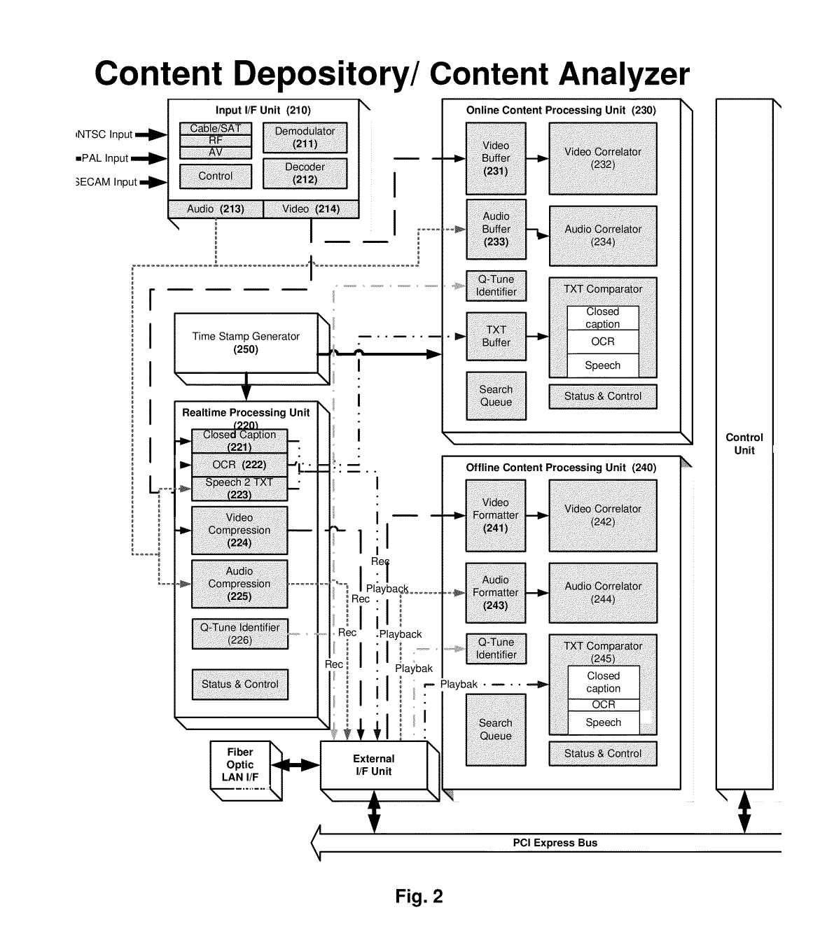

FIG. 2 is a schematic diagram of a content depository/content analyzer (CDCA), constructed according to the principles of the present invention. The CTCA has four major units. The first unit is the input unit 210 comprising a demodulator 211, a decoder 212, a separated audio component 213 and a separated video component 214.

Separated audio component 213 and separated video component 214 are both sent to the Real Time processing unit 220 and the Online Content Processing unit 230. Real Time processing unit 220 processes with closed caption unit 221, optical character recognition (OCR) unit 222, speech-to-text unit 223, video compression unit 224, audio compression unit 225 and Q-Tone Identifier 226, which cues the positioning of an advertisement, for example. Real time and online information is marked by a Time Stamp Generator 250.

Closed caption signals are derived as follows. In T.V. broadcast signals comprise 500 lines. Line 21 is not visible, but rather it's an ASCII string. In real time the result is seen as a closed caption. Most broadcasters already comply with the federal requirement in the U.S. that everything, including talk shows, needs to make available closed caption. It's not accurate, because a professional person is transcribing the voices as best he can. But one gets a good idea of the conversation. E.g., if the words “George Bush” are mentioned, they will definitely appear in the closed caption.

For real time, the viewer uses the remote control, which by law has one option called “closed caption,” . . . off or on. If one puts it on, for example during a talk show, the transcription appears on the bottom of the screen.

In another aspect of audio processing, the audio signal is fed to speech-to-text processing unit 223, preferably for transcription by an automated processor. Thus, the audio can be cross checked for accuracy between closed caption unit 221 and speech-to-text unit 223. Furthermore the Audio unit 234 could identify independent audio such as speech or music.

OCR unit 222 is used, for example, because a billboard may appear on the screen. The text is captured by OCR unit 222. Online Content Processing unit 230 does real time analysis of the audio in an audio buffer 231 and an audio correlator 232, analysis of the video in a video buffer 233 and a video correlator 234, as is, i.e., without compression and analysis of all forms text in a text buffer 235 and text comparator 236.

Offline Content Processing unit 240 does (frequently vast) archival analysis. This includes analysis of the audio in an audio buffer 241 and an audio correlator 242, analysis of the video in a video buffer 243 and a video correlator 244, as is, i.e., without compression and analysis of all forms of text in a text comparator 245. Archived data has already been time stamped.

The controller for a very fast fiber optic LAN 250 is able to provide transfer of up to 10 Gb/s compressed data.

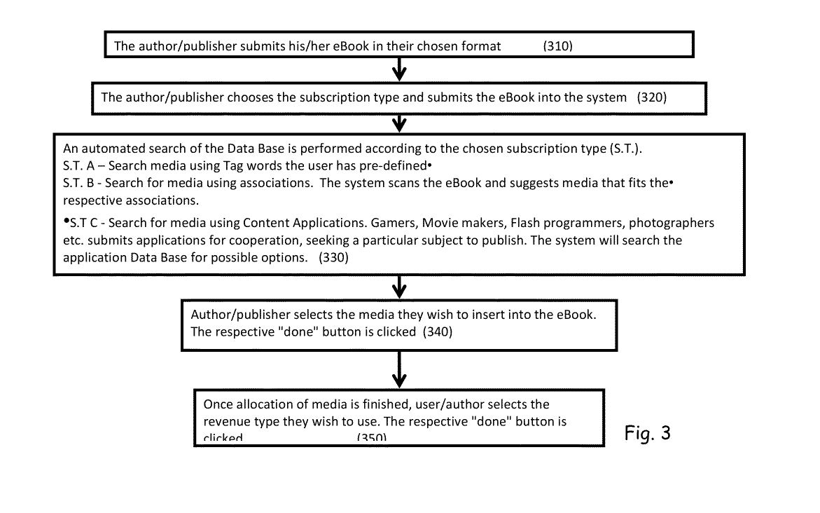

FIG. 3 is a flow chart of the user submission process, constructed according to exemplary embodiments of the present invention. An author/publisher submits his/her eBook in a chosen format 310. eBook formats include Word, EPUB and Kindle (AZW). The author/publisher chooses the subscription type and submits the eBook to the system 320. An automated search of the Data Base is performed according to the chosen subscription type (S.T.), A and B are for author/publishers and C is for author/publishers or content application providers:

S.T. A—Search media using Tag words the user has pre-defined;
S.T. B—Search for media using associations. The system scans the eBook and suggests media that fits the respective associations; and
S.T C—Search for media using Content Applications. Gamers, Movie makers, Flash programmers, photographers etc. submits applications for cooperation, seeking a particular subject to publish. The system will search the application Data Base for possible options 330.

Tag words are words directly found in the eBook text. Associations are words or concepts closely associated with or derived from keywords in the text, but the associations themselves, generally do not appear in the text.

The user reviews the search results and selects the media segments to be inserted into the eBook. The respective “done” button is clicked 340. Once allocation of a media segment is finished, the author/publisher selects the revenue type to use. Again, the respective “done” button is clicked 350.

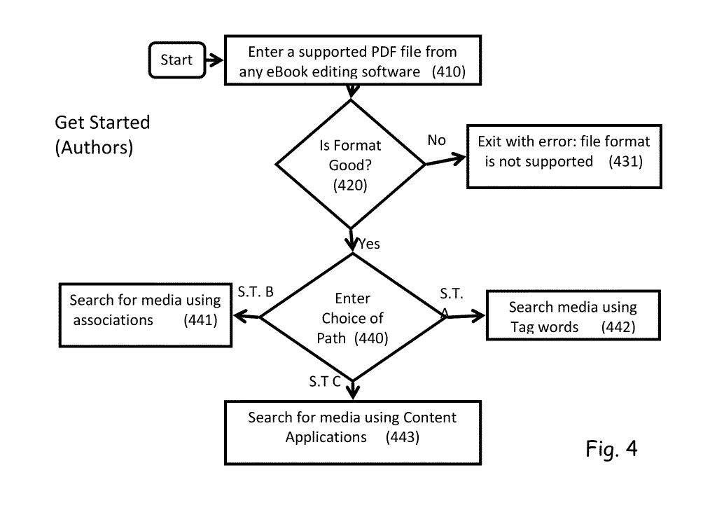

FIG. 4 is a flow chart of how the user begins the subscription process, constructed according to exemplary embodiments of the present invention. After subscribing, the user starts by entering a supported PDF file from any eBook editing software 410. If the format is not good there is an Exit with error message: “File Format Is Not Supported” 431. If the format is good, the author publisher enters a Choice of Path 440. Again, A and B are for author/publishers and C is for author/publishers or content application providers:

S.T. A—Search media using Tag words the user has pre-defined 441;

S.T. B—Search for media using associations. The system scans the eBook and suggests media that fits the respective associations 442; and

S.T C—Search for media using Content Applications. Gamers, Movie makers, Flash programmers, photographers etc. submits applications for cooperation, seeking a particular subject to publish 443.

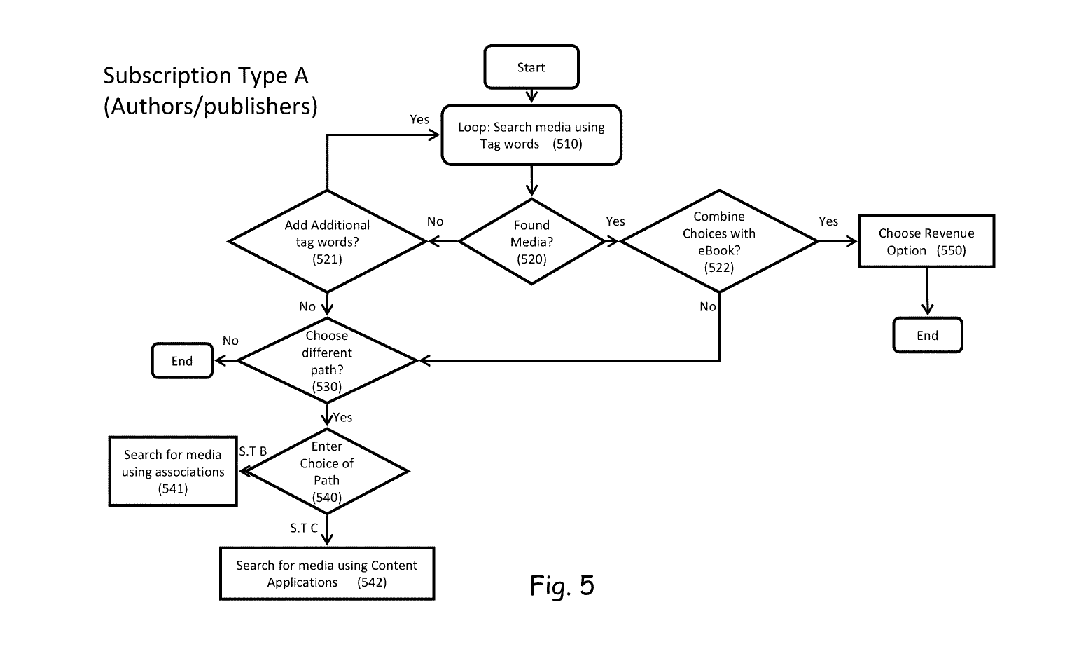

FIG. 5 is a flow chart of the author/publisher tag word subscription process, constructed according to exemplary embodiments of the present invention. The author/publisher starts by entering a search loop, selecting Tag words and searching media in the database for occurrences of the Tag words 510. Once appropriate media segments are found and selected the author/publisher decides whether to combine the choices with the eBook 522, and if so chooses and implements a revenue option 550. If appropriate media segments are not found 520 additional Tag words may be added 521, and the loop continues 510. Upon deciding not to combine the choices with the eBook 522 a different path may be chosen 530 and entered 540: search for media using associations 541 or search for media using Content Applications 542.

For example, if a reader of an eBook is browsing the book, and a page is opened that includes a description of a singing cowboy, then the system is queued to play an audio clip of movie star Gene Autry (known as “the singing cowboy”) singing: “Happy Trails to You,” his theme song, particularly played at the beginning and end of every episode of his TV series.

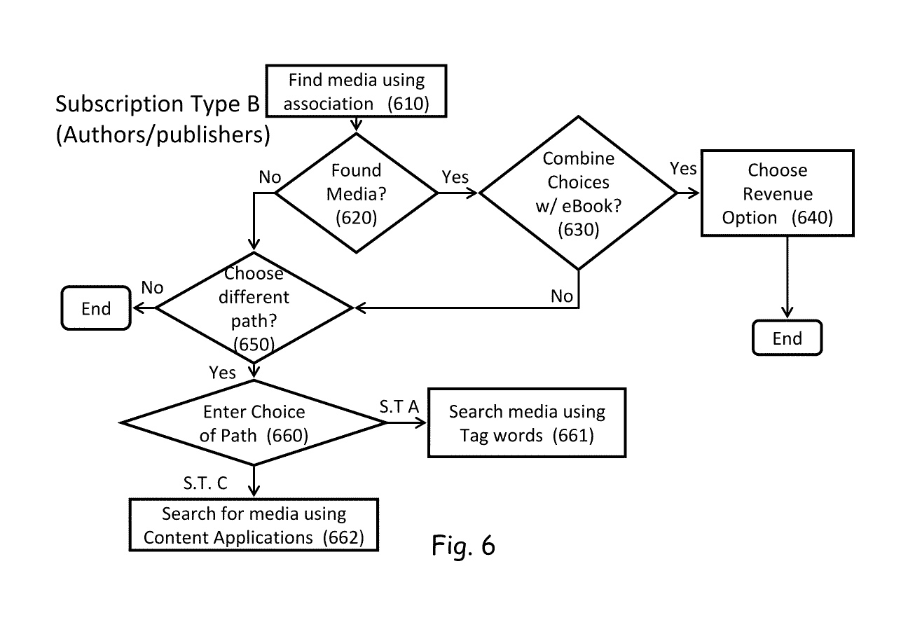

FIG. 6 is a flow chart of the author/publisher association subscription process, constructed according to exemplary embodiments of the present invention. The author/publisher enters the loop to find media using association 610. Once appropriate media segments are found by association 620, and are selected by the author/publisher, the author/publisher decides whether to combine the choices with the eBook 640, and if so chooses and implements a revenue option 640. If appropriate media segments are not found 620 a different path may be chosen 650 and entered 660: search for media using tag words 661 or search for media using Content Applications 662.

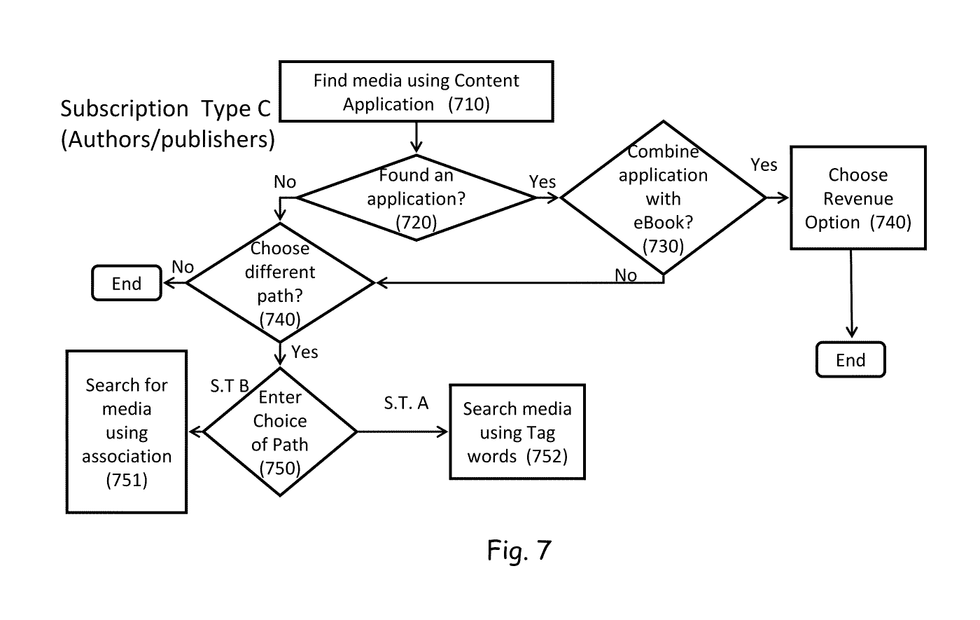

FIG. 7 is a flow chart of the author/publisher content application subscription process, constructed according to exemplary embodiments of the present invention. The author/publisher enters the loop to find media using content application 710. Once appropriate media segments are found by content application 720, and are selected by the author/publisher, the author/publisher decides whether to combine the choices with the eBook 730, and if so chooses and implements a revenue option 740. If appropriate media segments are not found 720 a different path may be chosen 740 and entered 750: search for media using tag words 752 or search for media using associations 751.

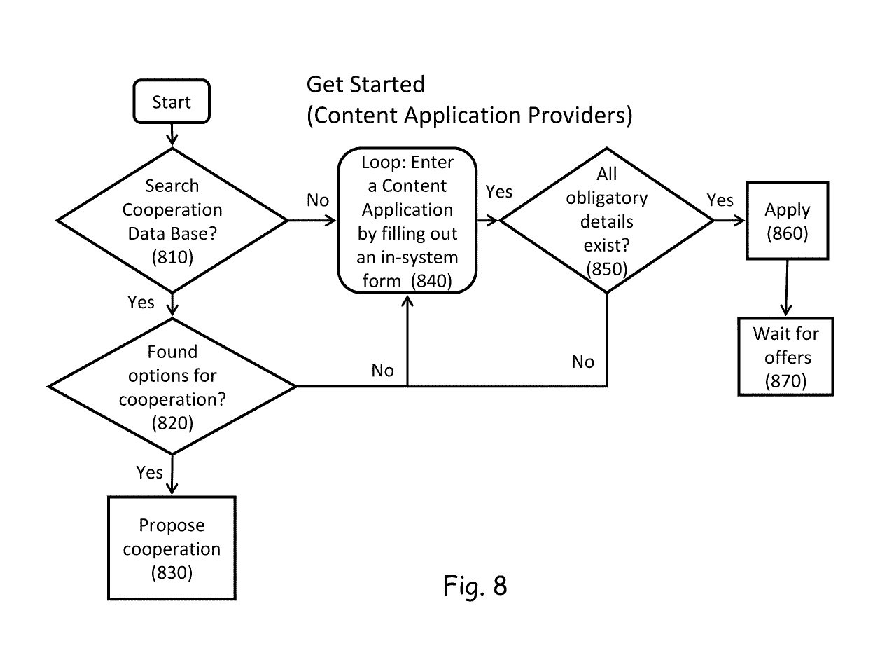

FIG. 8 is a flow chart of how the content application providers get started, constructed according to exemplary embodiments of the present invention. A content application provider starts by deciding whether to search the cooperation Data Base 810 by looking for offers that have been made relating to proprietary content. If the option to search is undertaken and relevant options for cooperation are found 820, the content application provider may propose cooperation accordingly 830. For example, if the content application provider has produced a film clip that includes footage of one or more Harley-Davidson motorcycles, and the brand name appears in the eBook text, the content application provider may propose inclusion of the film in the margin while the relevant page is on the screen. Alternatively, if the author/publisher is searching the same database and finds mention of the brand name, there can be a proposal to the manufacturer for having the name [symbol] appear in logo format.

If there is no search of the cooperation database, the content application provider may enter a new content by filling out an in-system form 840. If all required details have been entered 850, the content application is applied 860 and the content application provider waits for offers 870. If all required details have not been entered 850, the content application provider continues to loop on filling out the form 840 until the form requirements are all satisfied 850.

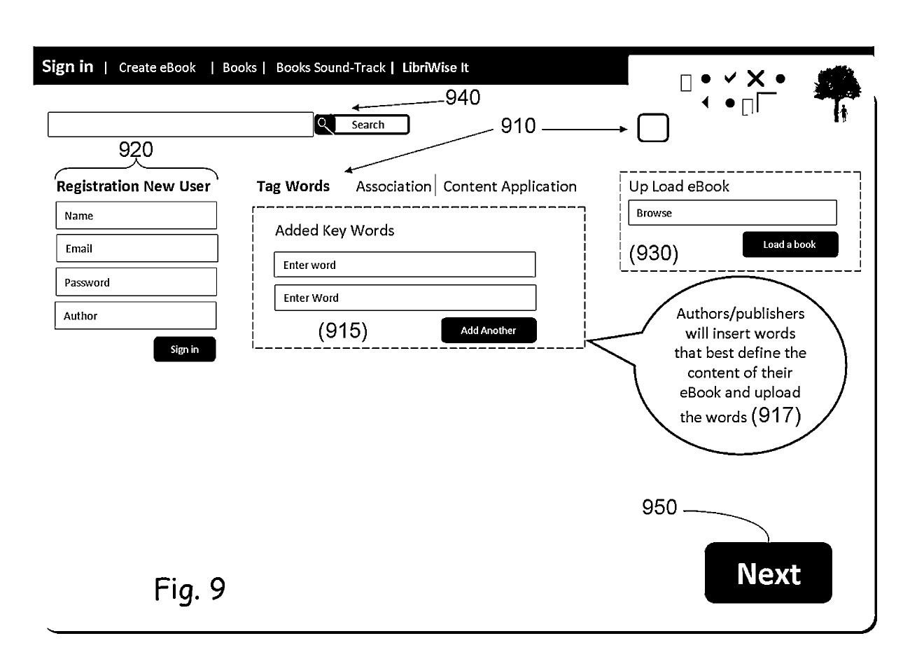

FIG. 9 is a screen shot layout of the 1^{st} of 5 tag word screens 910, constructed according to exemplary embodiments of the present invention. This introductory screen includes new user (author/publisher, content consumer or reader) registration/log-in 920; search mode, with “tag Words” selected 915; and “Up Load eBook” window 930. On this screen Authors/publishers can insert words that best define the content of their eBook and upload the words 917, and users can search for eBooks on a particular topic 940. Clicking “Next” 950 will bring up the 2^{nd} of 5 tag word screens, “Send cooperation request.”

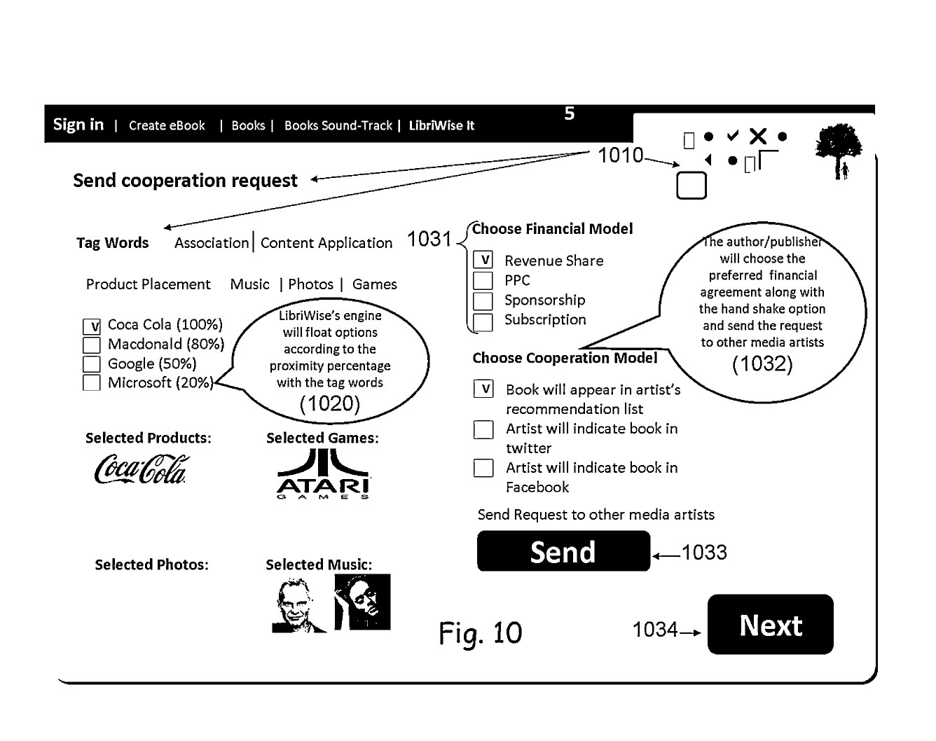

FIG. 10 is a screen shot layout of the 2^{nd} of 5 tag word screens, “Send cooperation request” 1010, constructed according to exemplary embodiments of the present invention. In the Tag words toolbar “Product Placement” 1020 has been selected. The engine will float options according to the proximity percentage with the tag words 1020. The author/publisher will choose the preferred financial agreement 1031 along with the hand shake option 1032 and send the request to other media artists 1033. Clicking “Next” 1034 will bring up the 3^{rd} of 5 tag word screens, “Receive confirmation for cooperation.”

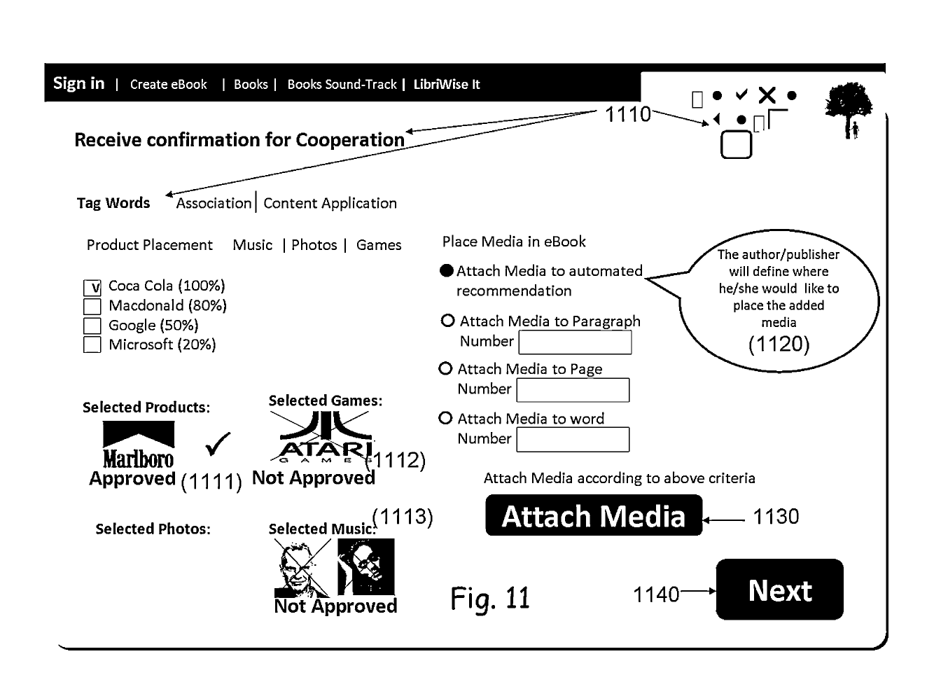

FIG. 11 is a screen shot layout of the 3^{rd} of 5 tag word screens, “Receive confirmation for cooperation” 1110, constructed according to exemplary embodiments of the present invention. One selected product has been approved 1111 and one selected game 1112 and two musical selections 1113 have not been approved. The author/publisher will define where he/she would like to place the added media 1120. The “Attach” button is clicked and the media is attached; according to the selected criteria 1130. Clicking “Next” 1140 will bring up the 4^{th} of 5 tag word screens, “Approve,” or go “Back.”

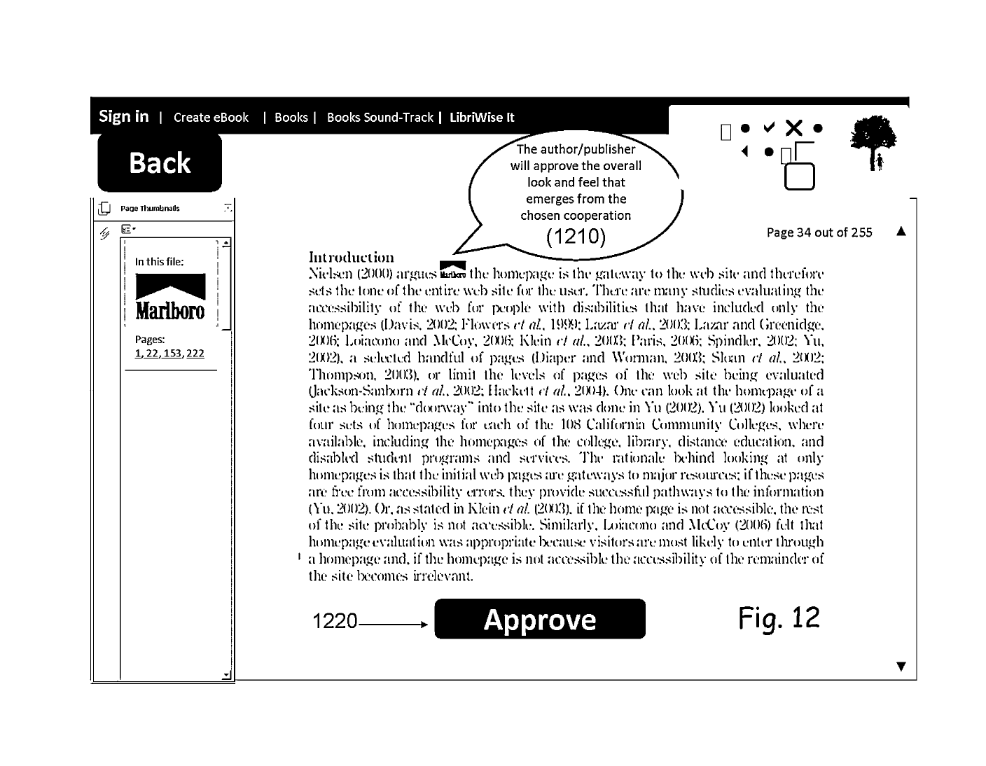

FIG. 12 is a screen shot layout of the 4^{th} of 5 tag word screens, “Approve,” or go “Back,” 1210, constructed according to exemplary embodiments of the present invention. The author/publisher may approve the overall look and feel that emerges from the chosen cooperation 1220. Clicking “Approve” 1220 will invoke the 5^{th} of 5 tag word screens “Reports.”

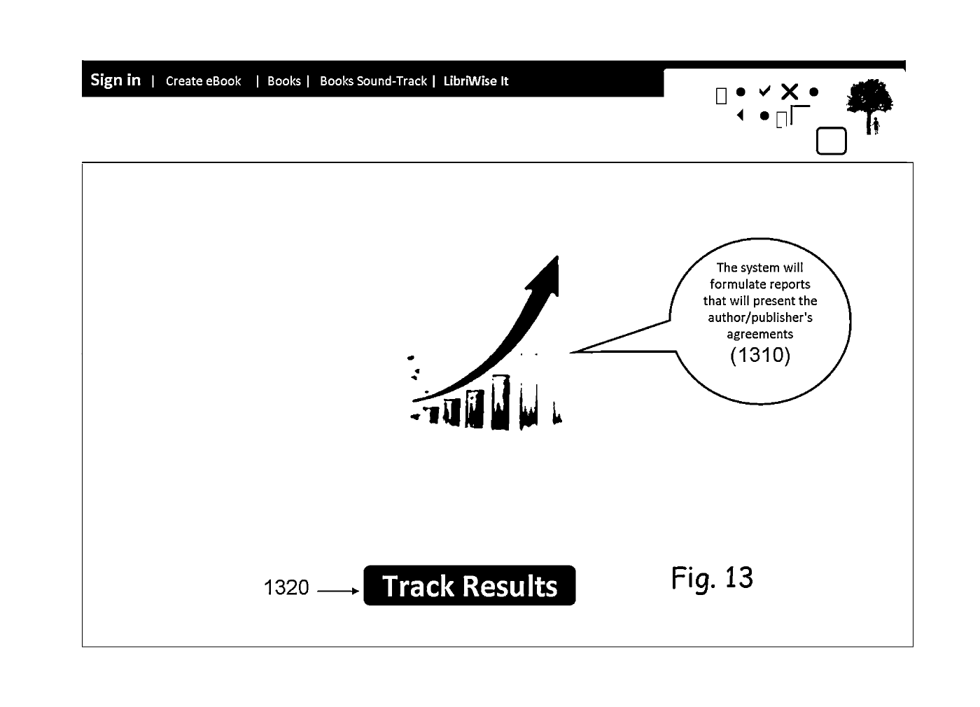

FIG. 13 is a screen shot layout of the 5^{th} of 5 tag word screens, “Reports,” constructed according to exemplary embodiments of the present invention. The system will formulate reports that will present the author/publisher's agreements 1310. These reports can be accessed from this screen by clicking “Track Results” 1220.

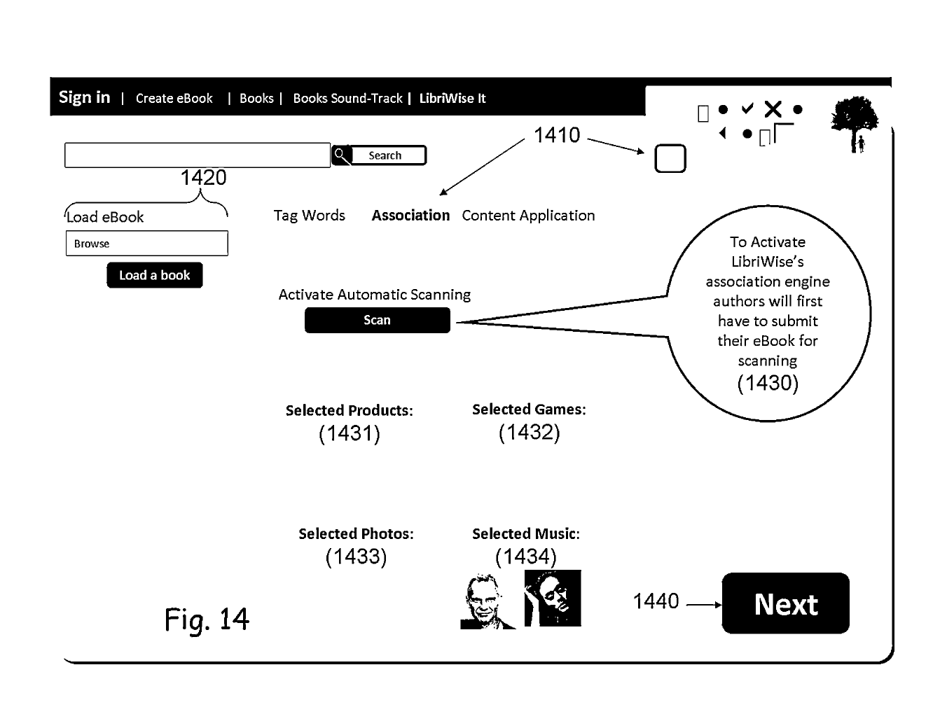

FIG. 14 is a screen shot layout of the 1^{st} of 5 association screens 1410, constructed according to exemplary embodiments of the present invention. To Activate LibriWise's association engine authors/publishers will first preferably load their eBook 1420 and then select products 1431, games 1432, photos 1433 and/or music 1434 for scanning 1430. Clicking “Next” 1440 will bring up the 2^{nd} of 5 association screens, “Send cooperation request.”

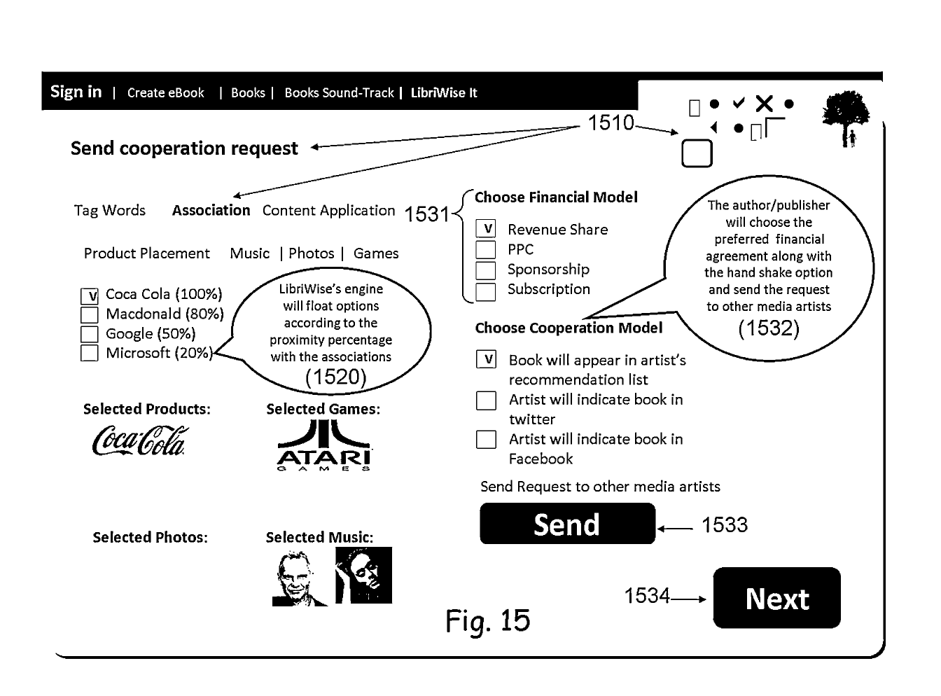

FIG. 15 is a screen shot layout of the 2^{nd} of 5 association screens, “Send cooperation request” 1510, constructed according to exemplary embodiments of the present invention. In the association toolbar “Product Placement” 1520 has been selected. The engine will float options according to the proximity percentage with the tag words 1520. The author/publisher will choose the preferred financial agreement 1531 along with the hand shake option 1532 and send the request to other media artists 1533. Clicking “Next” 1534 will bring up the 3^{rd} of 5 association screens, “Receive confirmation for cooperation.”

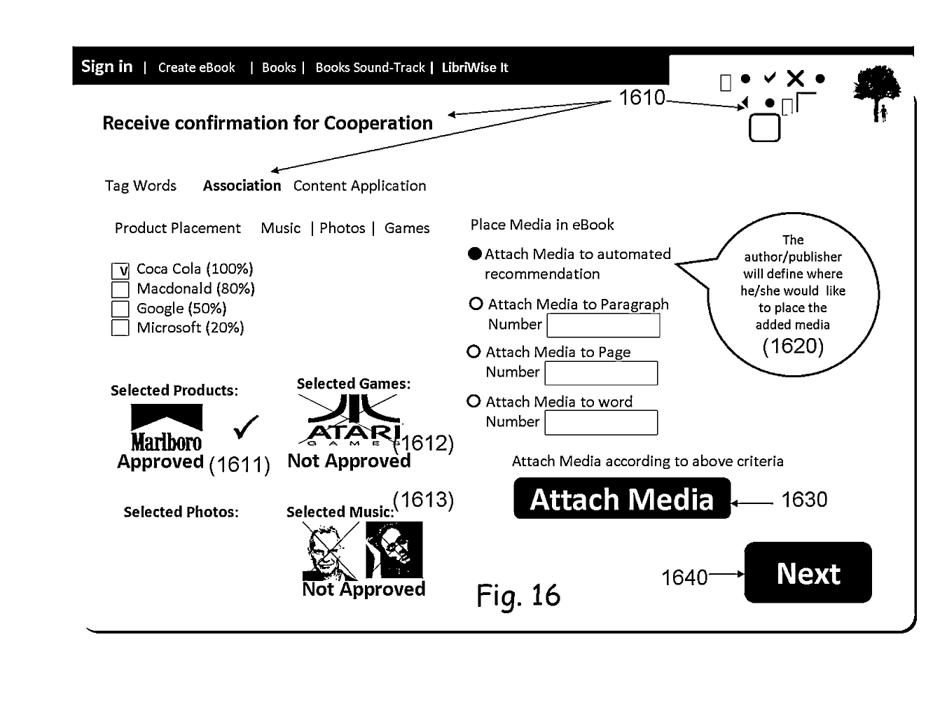

FIG. 16 is a screen shot layout of the 3^{rd} of 5 association screens, “Receive confirmation for cooperation” 1610, constructed according to exemplary embodiments of the present invention. One selected product has been approved 1611 and one selected game 1612 and two musical selections 1613 have not been approved. The author/publisher will define where he/she would like to place the added media 1620. The “Attach” button is clicked and the media is attached; according to the selected criteria 1630. Clicking “Next” 1640 will bring up the 4^{th} of 5 association screens, “Approve,” or go “Back.”

A screen shot layout of the 4^{th} of 5 association screens and the 5^{th} of 5 association screens are the same as the screen shot layouts for FIG. 12 “Approve,” or go “Back,” and FIG. 13, “Reports,” respectively.

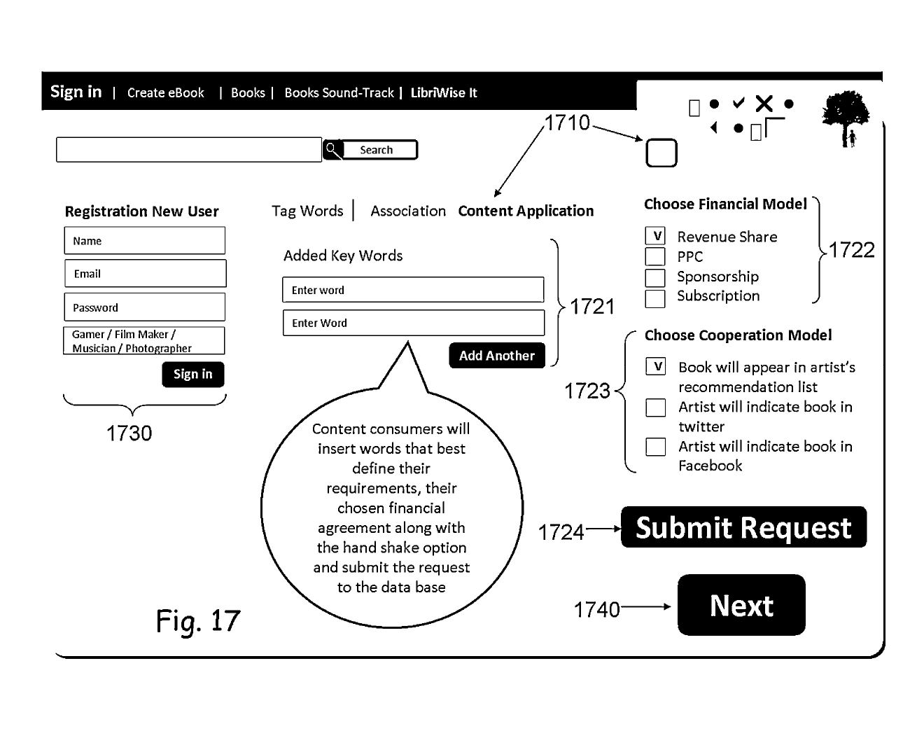

FIG. 17 is a screen shot layout of the 1^{st} of 3 content application screens, constructed according to exemplary embodiments of the present invention. Content consumers, such as gamers, movie makers, flash programmers, photographers, etc. will submit applications for cooperation, seeking a particular subject they wish to use in their line of work, i.e. game, movie, TV series etc. The system will search the application Data Base for possible options.

Content consumers will insert words that best define their requirements 1721, choose their financial agreement 1722 along with the hand shake option 1723 and submit the request to the data base 1724. Content consumer registration and login are also provided 1730. Clicking “Next” 17400 will bring up the 2^{nd} of 5 content consumer screens, “Send cooperation request.”

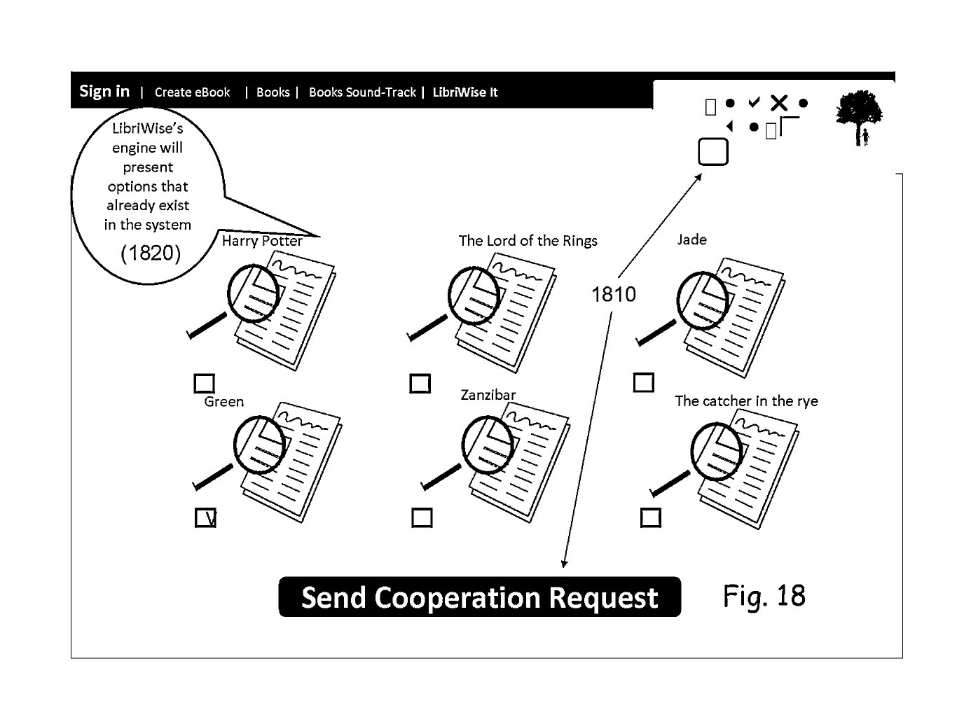

FIG. 18 is a screen shot layout of the 2^{nd} of 3 content application screens, “initiate Send cooperation request” 1810, constructed according to exemplary embodiments of the present invention. In response to keywords 1721 inserted with reference to FIG. 17, LibriWise's engine will present options that already exist in the system 1820.

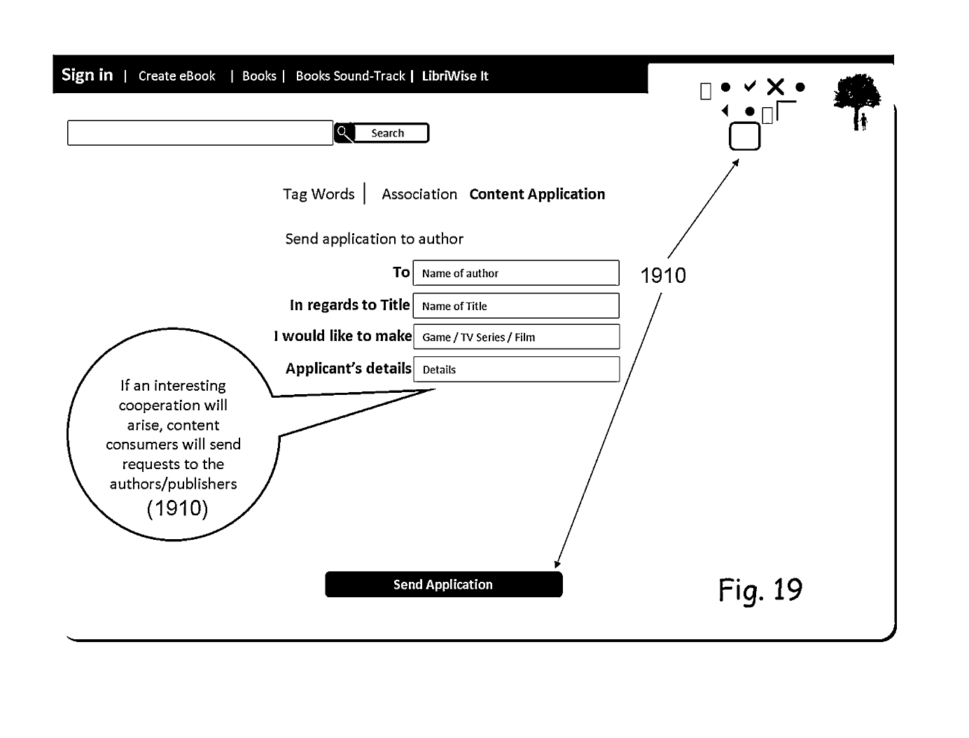

FIG. 19 is a screen shot layout of the 3^{rd} of 3 content application screens, “Send application for cooperation request” 1910, constructed according to exemplary embodiments of the present invention. If an interesting cooperation will arise, content consumers will send requests to the authors/publishers 1920.

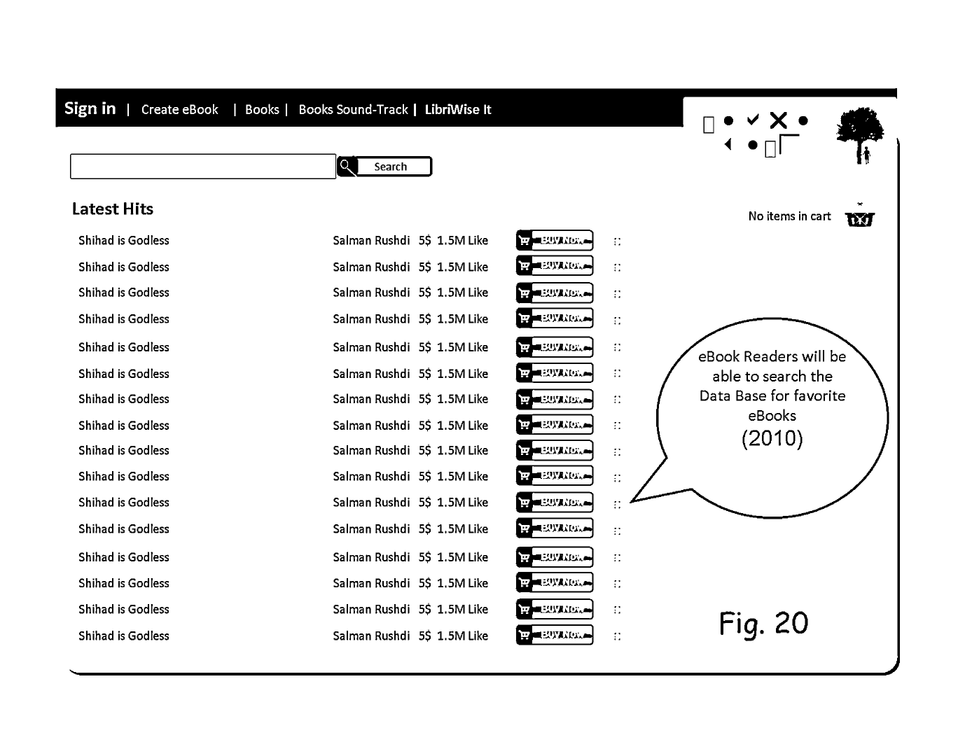

FIG. 20 is a screen shot layout of a reader search of the data base for favorite eBooks, constructed according to exemplary embodiments of the present invention. eBook readers will be able to search the Data Base for their favorite eBooks 2010.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A website-based system for eBook distribution and monetization and to enhance the eBook reading experience by insertion into the eBook format of other media from other media providers, the system comprising:
at least one server to interact with authors/publishers, content consumers and eBook readers;
a readily searchable database compiled from relevant media;
a runtime engine to map the eBooks and to search the database as needed; and
tools that will enable the insertion of other media into the eBook, such as
photos, music, video, flash elements and content placement into the eBook, thereby creating a better user experience, one that will round out the reading process and create a hand shake between authors and other media artists.

2. The website-based system for eBook distribution and monetization, wherein the hand shake will result in a joint audience as both eBook authors/publishers and other media providers will expose their work to the other's audience.
It is one more principal object of the present invention to provide a social networking system for authors/publishers to facilitate distribution and monetization of their eBooks.

3. The website-based system of claim 1, wherein the other media comprise selections from at least photos, music, video, games and flash elements.

4. A method for distributing and monetizing eBooks by the system of claim 1, the method comprising:
subscribing by a plurality of authors/publishers to the system;
choosing by the author/publisher of a subscription type for his/her eBook;
searching media by the author/publisher according to subscription type for desirable material to insert into his/her eBook;
selecting from search results, if any, of material to insert into the eBook;
choosing a revenue option; and
submitting by an author/publisher of an eBook to the system.

5. The method of claim 4, wherein the method of subscription is based on tag words that best define the content of the eBook and the method further comprises floating by the runtime engine of options according to the proximity percentage with the tag words.

6. The method of claim 4, wherein the method of subscription is association.

7. The method of claim 4, wherein the method of subscription is content application.

8. The method of claim 4, further comprising choosing by the author/publisher of a preferred hand shake option and sending the request to other media artists.

9. The method of claim 8, further comprising sending confirmation by at least one of the other artists and receiving the confirmation for cooperation by the author/publisher.

10. The method of claim 9, further comprising specifying by the author/publisher where he/she would like to place the added media content of the at least one other artist and attaching the media accordingly.

11. The method of claim 10, further comprising approving by the author/publisher of the overall look and feel that emerges from the chosen cooperation.

12. The method of claim 11, further comprising formulating reports by the system that will present the author/publisher's agreements.
